(19) United States
(12) Patent Application Publication
(10) Pub. No.: US 2005/0217484 A1
(43) Pub. Date: Oct. 6, 2005

(54) Method and portable apparatus for cooling and heating structures

(76) Inventors: Claude Bourgault, St. Brieux (CA); Larry Dancey, Melfort (CA)

Correspondence Address: NIXON & VANDERHYE, PC, 901 NORTH GLEBE ROAD, 11TH FLOOR, ARLINGTON, VA, 22203, US

(21) Appl. No.: 11/137,486

(22) Filed: May 26, 2005

Related U.S. Application Data
(63) Continuation-in-part of application No. 10/751,455, filed on Jan. 6, 2004.

(30) Foreign Application Priority Data
Aug. 31, 2004 (CA) 2,479,639

(51) Int. Cl. F25B 45/00; B01D 45/00; B01D 46/00; B01D 50/00; B01D 47/00; B01D 51/00; B01D 49/00; B01D 53/14; B01D 59/50; B01D 39/00; B01D 41/00

(52) U.S. Cl. 95/273; 96/224; 55/385.1

(57) ABSTRACT

A portable apparatus for heating and cooling a plurality of structures comprises a fluid heater operative to supply warm fluid, a fluid chiller operative to supply cool fluid, and a plurality of portable heat exchanger units, each comprising a fluid coil and a fan operative to create an air stream through the fluid coil. A pump is operatively connected to the fluid heater, fluid chiller, and fluid coils and is operative, when the apparatus is in a heating mode, to pump warm fluid from the fluid heater through the fluid coils, and is operative, when the apparatus is in a cooling mode, to pump cool fluid from the fluid chiller through the fluid coils. The fluid heater, fluid chiller, portable heat exchanger units, and pump are operatively connected by releasable connections such that the apparatus can be transported in parts and assembled at a desired destination.

This invention is in the field of controlling temperature in buildings, tents, and like enclosed spaces, and in particular heating and cooling structures using portable means.

### BACKGROUND

Temporary camps are set up to provide housing, office, and like enclosures for personnel in many different situations. There may be a work force needed for a short time in a location where conventional buildings are not available on a short-term basis, or in a remote location where conventional buildings are not available at all. Construction, mining, oilfield, and military operations often require temporary housing and operations structures to accommodate significant numbers of people, as well as considerable supplies and equipment, for a relatively short time.

For cost efficiency and convenience, it is desirable to have the camp comprise structures and ancillary equipment that can be quickly taken down, moved, and set up again. For example it is imperative that military camps be quickly portable to preserve the ability of the force to move quickly in the field. At the same time, in order to maintain a reasonably content and efficient work force, it is desirable to provide a camp environment that is as comfortable as possible in the circumstances.

Often such camps are set up in remote areas with no access to an electrical grid, requiring that electrical requirements be provided by an engine driven generator. Also in order to preserve the ability of a military unit to set up camp wherever necessary, it is desirable that it be self contained such that there is no reliance on or necessity for outside resources. Reducing electrical power requirements so that same can be readily supplied by a portable generator is thus desirable.

Conventionally when setting up camps, heating is provided by portable heaters that burn fuel such as diesel or propane and are located as required in each tent, portable building, or like structure. Such heaters can be fire hazards, and can also release fumes into the structure. Resistance type electric heaters are therefore commonly used, however operating them is especially costly when power must be locally generated by a diesel generator. Diesel fuel to heat energy conversion efficiency can be as low as 30%.

Cooling is less commonly provided in temporary camps, since portable air conditioning units require significant electricity, and also add considerably to the amount of equipment that must be transported. Where such heating and cooling is desired in temporary structures, systems that are essentially similar to building rooftop units are used. These units sit on the ground outside and must therefore be connected to the structure with supply and return ducts. Thus set-up and re-packing for transport is time consuming, and operation is costly, again commonly using diesel generated electricity for operating the units.

In addition to heating and cooling, in military camps it would also be desirable to be able to scrub the air inside the temporary structures to remove micro-organisms used in biological warfare, such as anthrax bacteria and spores, that might be used in an attack. Field hospitals and medical stations especially would benefit from such scrubbing.

### SUMMARY OF THE INVENTION

It is an object of the present invention to provide a method and portable apparatus for controlling the temperature inside structures that overcomes problems in the prior art.

The present invention provides, in a first embodiment, a portable apparatus for heating and cooling a plurality of structures. The apparatus comprises a fluid heater operative to supply warm fluid, a fluid chiller operative to supply cool fluid, and a plurality of portable heat exchanger units, each portable heat exchanger unit comprising a fluid coil and a fan operative to create an air stream through the fluid coil by drawing air from an intake and discharging the air through an outlet. At least one pump is operatively connected to the fluid heater, fluid chiller, and fluid coils and is operative, when the apparatus is in a heating mode, to pump warm fluid from the fluid heater through the fluid coils, and is operative, when the apparatus is in a cooling mode, to pump cool fluid from the fluid chiller through the fluid coils. The fluid heater, fluid chiller, portable heat exchanger units, and at least one pump are operatively connected by releasable connections such that the apparatus can be transported in parts and assembled at a desired destination.

The present invention provides, in a second embodiment, a portable apparatus for heating and cooling a plurality of structures. The apparatus comprises a portable heating module comprising a fluid heater operative to supply warm fluid and a warm pump operative to pump warm fluid from the fluid heater to an outbound manifold; a portable cooling module comprising a fluid chiller operative to supply cool fluid and a cool pump operative to pump cool fluid from the fluid chiller to the outbound manifold; and a plurality of portable heat exchanger units, each portable heat exchanger unit comprising a fluid coil and a fan operative to create an air stream through the fluid coil by drawing air from an intake and discharging the air through an outlet. A return manifold is operatively connected to the fluid heater and fluid chiller. A flexible outbound conduit connects the outbound manifold to an inlet end of each fluid coil, and a flexible return conduit connects the return manifold to an outlet end of each fluid coil. A control system is operative to switch the apparatus between a heating mode, wherein the warm pump pumps warm fluid from the fluid heater through the fluid coils and back to the fluid heater, and a cooling mode wherein the cool pump pumps cool fluid from the fluid chiller through the fluid coils and back to the fluid chiller. The heating module, cooling module and portable heat exchanger units are operatively connected by releasable connections such that the apparatus can be transported in parts and assembled at a desired destination.

The present invention provides, in a third embodiment, a method of heating and cooling a plurality of temporary structures at a camp site. The method comprises providing at least two separately transportable modules comprising a fluid heater operative to supply warm fluid; a fluid chiller operative to supply cool fluid; a plurality of portable heat exchanger units, each portable heat exchanger unit comprising a fluid coil and a fan operative to create an air stream through the fluid coil by drawing air from an intake and discharging the air through an outlet; and at least one pump; transporting the at least two transportable modules to the camp site; operatively connecting the fluid heater, fluid chiller, fluid coils, and at least one pump such that the at least one pump is operative to selectively pump warm fluid and cool fluid through the fluid coils; orienting the outlet of each portable heat exchanger unit to discharge the air stream into at least one temporary structure; to heat the temporary structures, pumping warm fluid through the fluid coils and operating the fans to create a warm air stream; and to cool the temporary structures pumping cool fluid through the fluid coils and operating the fans to create a cool air stream.

The present invention provides a method and apparatus that provides both heating and cooling with a single portable heat exchanger unit located inside or adjacent to the structure. The apparatus comprises a portable heat exchanger unit comprising a fluid coil connected to either a boiler or like heating device such that hot fluid flows through the fluid coil to heat the structure, or a fluid chiller such that cool fluid flows through the fluid coil to cool the structure.

The apparatus can be configured to draw outside air into the structure to generate a positive pressurize inside the structure, and filter air being drawn in using HEPA (High Efficient Particulate Attenuation) filters to remove hazardous micro-organisms that can be hazardous to health. The apparatus can be further configured to use ultra-violet light to kill micro-organisms.

The invention provides a conveniently portable apparatus and method for heating and cooling a number of structures at a remote camp site using a fuel source that is readily available at the site. In addition the air inside the structures could be scrubbed to remove micro-organisms for biological warfare, such as anthrax bacteria and spores, that might be used in an attack. Outside air could be drawn in through the HEPA filters and irradiated with ultra-violet light, thereby removing a very high proportion of the microorganisms, and pressurizing the interior of the structure. With positive pressure on the interior, contaminated outside air is substantially prevented from entering the structure.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of an embodiment of the apparatus of the invention set up in a typical array of structures such as might be found in a construction or military camp;

FIG. 2 is a schematic top view of an alternate embodiment of the apparatus using a single pump to circulate both warm and cool fluid;

FIG. 3 is a schematic side view of a portable heat exchanger unit.

### DETAILED DESCRIPTION OF THE ILLUSTRATED EMBODIMENTS

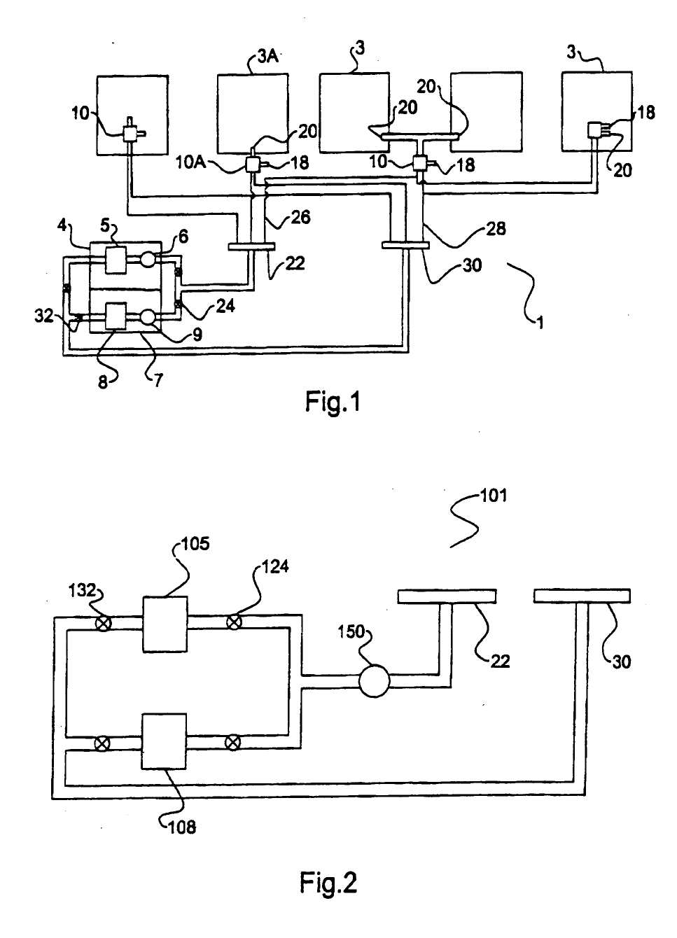

FIG. 1 schematically illustrates a portable apparatus 1 for heating and cooling a plurality of structures 3. A typical application of the apparatus 1 would be to heat and cool temporary structures such as tents, portable buildings, or the like such as would be located in a construction, oilfield, mining, or military camp site.

The apparatus 1 comprises a portable heating module 4 and a portable cooling module 7. The heating module 4 comprises a fluid heater 5 operative to supply warm fluid and a warm pump 6, operative to pump warm fluid from the fluid heater 5, mounted on a pallet, deck or the like such that the heating module 4 can be readily transported. Similarly the cooling module 7 comprises a fluid chiller 8 operative to supply cool fluid and a cool pump 9, operative to pump cool fluid from the fluid chiller 8, mounted on a pallet, deck or the like such that the cooling module 7 can be readily transported.

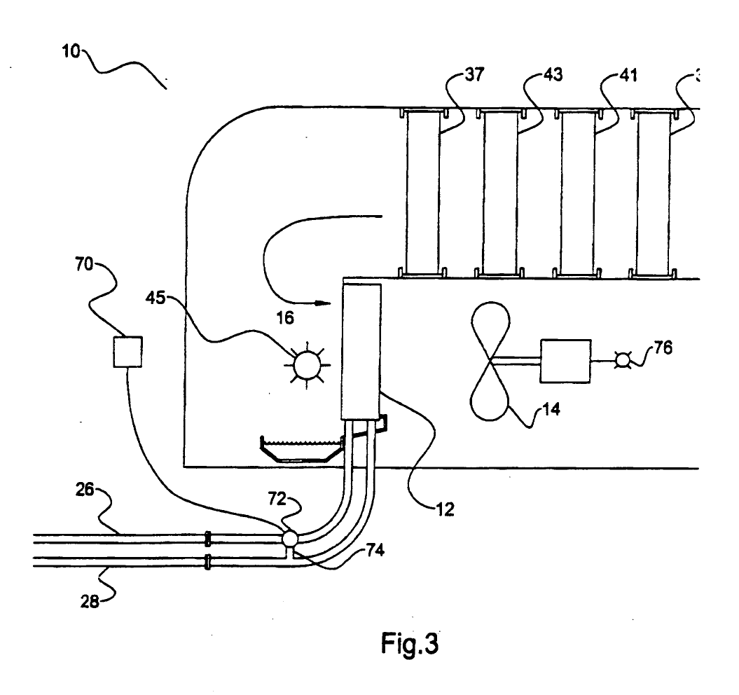

A plurality of portable heat exchanger units 10 each comprise, as illustrated in FIG. 3, a fluid coil 12 and a fan 14 operative to create an air stream 16 through the fluid coil 12 by drawing air from an intake 18 and discharging the air through an outlet 20.

Once the heating and cooling modules 4, 7 and portable heat exchanger units 10 have been transported to the camp site, the warm and cool pumps 6, 9 are operatively connected to the fluid coils 12 using releasable connectors. The portable heat exchanger units 10 can be placed as required. Larger temporary structures could require two portable heat exchanger unit 10, while other structures might be small enough that a single portable heat exchanger unit 10 could be used to heat two or more structures by connecting a plurality of output ducts to the outlet 20. Considerable flexibility is thus provided by the system of the invention.

A control system is operative to switch the apparatus 1 between a heating mode, wherein the warm pump 6 pumps warm fluid from the fluid heater 5 through the fluid coils 12 and back to the fluid heater 5, and a cooling mode wherein the cool pump 9 pumps cool fluid from the fluid chiller 8 through the fluid coils 12 and back to the fluid chiller 8.

In the illustrated embodiment the outputs of the warm and cool pumps 6, 9 are connected to an outbound manifold 22 through output control valves 24. A flexible outbound conduit 26 releasably connects the outbound manifold 22 to the inlet end of each fluid coil 12 and a flexible return conduit 28 releasably connects the outlet end of each fluid coil 12 to a return manifold 30 that in turn is connected to the fluid heater 5 and fluid chiller 8 through return control valves 32. The flexible conduits 26, 28 would typically be insulated hoses which could be placed around corners and the like as required to suit a typical layout of structures.

A basic control system could comprise simply turning the fluid heater 5 and warm pump 6 on and the fluid chiller 8 and cool pump 9 off to operate the apparatus 1 in the heating mode, and vice versa to operate in the cooling mode. The pumps 6, 9 would be configured such that when turned off fluid could not pass through them, so when one was operating, the only path would be through the operating pump and its associated fluid heater or cooler.

The illustrated embodiment further provides outbound and return control valves 24, 32 that are manipulated either manually or remotely to positively control the flow of fluid through the apparatus 1 during the heating and cooling modes.

The releasable connection of the heating module, cooling module and portable heat exchanger units facilitate quickly breaking the apparatus 1 down into parts that can be readily transported and then re-assembled at a desired destination.

FIG. 2 illustrates an alternate embodiment 101 wherein both the fluid heater 105 and fluid chiller 108 are connected to the intake of a single pump 150 through outbound control valves 124. The pump output is connected to the outbound manifold 22, and the return manifold 30 is connected to the fluid heater 105 and fluid chiller 108 through return control valves 132. In this alternate embodiment of FIG. 2 only one pump is required instead of the two required in the embodiment of FIG. 1. There are, however, advantages in flexibility provided by the embodiment of FIG. 1, since where required a heating or cooling module 4, 7 could be transported independently to set up a heating only or cooling only system where both heating and cooling are not required. Further, where conditions are very cold for example, two or more heating modules could be transported and connected to the manifolds 22, 30 to provide increased heating capacity.

As illustrated in FIG. 3, the portable heat exchanger unit 10 can also comprise a temperature control operative to regulate the flow of warm or cool fluid through the fluid coil 12 thereof in response to a sensed temperature. A thermostat 70 is connected to a bypass valve 72. When the sensed temperature at the thermostat 70 rises or falls to a cutoff point, the bypass valve 72 is opened or closed to direct fluid through the fluid coil or to the bypass line 74. A fan controller 76 can also be provided to change the speed of the fan 14 to vary the volume of the air stream 16.

Conveniently the fluid heater 5 will be provided by a boiler and the fluid chiller 8 will be provided by an absorption chiller. Such boilers and absorption chillers are well known in the art and are available in various capacities and fuel types. These can both be conveniently operated using the same fuel, such as propane, diesel, or the like and thereby reduce electrical requirements to a small amount required to operate pumps, controls and the like. The actual heating and cooling is accomplished by burning the fuel. For example a military or construction camp will typically use a considerable amount of diesel fuel, and it would be convenient to fuel the boiler and absorption chiller using the same fuel in order to avoid separate fuel storage and transport. In some situations a conventional refrigeration unit could provide the fluid chiller, however driving such units with electricity is not usually convenient, and is less efficient. Such refrigeration units are also available where the compressor is driven by an internal combustion engine, however these are considerably more expensive than absorption chillers.

It is contemplated that a 1,200,000 British Thermal Unit (BTU) boiler and a 300,000 BTU absorption chiller could be teamed to handle heating and cooling of five portable heat exchanger units in a temperate climate area such as the upper mid-west of the United States. The connection of the fluid heater 5 and cooler 8 to the outbound manifold 30 would typically be by a 2 inch diameter insulated hose up to about 400 feet long, with portable heat exchanger units located about 50 feet from the outbound manifold 22. Various configurations could be made by adding more manifolds 22, 30 by teeing into the manifold feed and return conduits, and adding portable heat exchanger units 10 by teeing into outbound conduits 26 and return conduits 28 at various locations.

It is typical that a common fluid distribution system capable of transferring 200,000 Btu/hour, at predetermined heating mode conditions, would be capable of transferring 60,000 Btu/hour (or 5 tons) at predetermined cooling mode conditions, if the fluid flow rate is equal in both cases. In temperate climate areas such as the upper mid-west of the United States this balance of winter heating and summer cooling needs is probably about correct. Colder or warmer climates would require designing system capacity in favor of the mode that has the greater demand.

The portable heat exchanger unit 10 illustrated in FIG. 3 further includes a HEPA filter 37 capable of High Efficient Particulate Attenuation located such that the air stream 16 passes through the HEPA filter 37. Suitable filters are capable of removing 99.97% of microorganisms or other air borne particles as small as 0.3 microns in diameter at the rated airflow. Manufacturers of certified HEPA filters will list the maximum design airflow for each size they offer. For example one available 24×12″×12″ filter is rated for a maximum of 855 cubic feet per minute (cfm), and a 24×24″×12″ filter is rated for a maximum of 1900 cfm.

The portable heat exchanger unit 10 includes coarse filters 39, 41 located upstream from the HEPA filter 37 such that the air stream passes through the coarse filters 39, 41 and is pre-filtered prior to passing through the HEPA filter 37. A typical pre-filtration process could be in two stages whereby the air stream 16 first passes through a rough, “loose-media” filter 39 followed by a pleated filter 41 with a MERV (minimum efficiency reporting value) of “8” by ASHRAE Standard 52.2. By changing the coarse filters 39, 41 regularly, the life of the more costly HEPA filter 37 can be prolonged.

The portable heat exchanger unit 10 also includes an activated carbon filter 43 located upstream from the HEPA filter 37 such that the air stream passes through the activated carbon filter 43 prior to passing through the HEPA filter 37. Such activated carbon filters will adsorb most airborne gases and odours.

Yet further the illustrated portable heat exchanger unit 10 also includes an ultra-violet light 45 oriented to irradiate the air stream 16 after the air stream 16 has passed through the HEPA filter. The ultra-violet rays are able to kill a significant proportion of most typical bacteria. The ultra-violet light 45 in combination with the HEPA filter 37 removes a very high proportion of micro-organisms, bacteria and the like, as well as other undesirable particles, from the air stream 16. In the illustrated embodiment, a drip pan 46 is oriented to catch condensed water dripping from the fluid coil 12 during a cooling operation. The ultra-violet light 45 is oriented to irradiate water collected in the drip pan 46 with ultra-violet light and prevent growth therein of bacteria and the like.

Thus the portable heat exchanger unit 10 has the capability of scrubbing as well as heating or cooling the intake air. In FIG. 1, portable heat exchanger unit 10A is oriented with the intake 18 outside to draw in outside air and discharge the scrubbed air stream into the structure 3A. Positive pressure is thus placed inside the structure 3A that will inhibit outside air from entering the structure 3A through any crack or opening in the structure 3A. For military camps, it could be desirable to be able to scrub the air inside the structures to remove micro-organisms used in biological warfare, such as anthrax bacteria and spores, that might be used in an attack. Further portable heat exchanger units 10 could be used in the interior of the structure 3A to further purify the inside air.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A portable apparatus for heating and cooling a plurality of structures, the apparatus comprising:
a fluid heater operative to supply warm fluid;
a fluid chiller operative to supply cool fluid;
a plurality of portable heat exchanger units, each portable heat exchanger unit comprising a fluid coil and a fan operative to create an air stream through the fluid coil by drawing air from an intake and discharging the air through an outlet;
at least one pump operatively connected to the fluid heater, fluid chiller, and fluid coils and operative, when the apparatus is in a heating mode, to pump warm fluid from the fluid heater through the fluid coils, and operative, when the apparatus is in a cooling mode, to pump cool fluid from the fluid chiller through the fluid coils;
wherein the fluid heater, fluid chiller, portable heat exchanger units, and at least one pump are operatively connected by releasable connections such that the apparatus can be transported in parts and assembled at a desired destination.

2. The apparatus of claim 1 wherein when the apparatus is in the heating mode the warm fluid is pumped through an outbound manifold and then through a plurality of outbound conduits to the fluid coils and returns through a plurality of return conduits to a return manifold and then to the fluid heater; and when the apparatus is in the cooling mode the cool fluid is pumped through the outbound manifold and then through the plurality of outbound conduits to the fluid coils and returns through the plurality of return conduits to the return manifold and then to the fluid chiller.

3. The apparatus of claim 1 comprising at least one valve operative to selectively connect the fluid heater and fluid chiller to an intake of the at least one pump.

4. The apparatus of claim 2 comprising a warm pump operative to pump warm fluid from the fluid heater through the fluid coils when the apparatus is in the heating mode, and a cool pump operative to pump cool fluid from the fluid chiller through the fluid coils when the apparatus is in the cooling mode.

5. The apparatus of claim 4 further comprising at least one outbound valve operative to selectively connect and disconnect the warm pump and cool pump to the outbound manifold to switch the apparatus between heating mode and cooling mode.

6. The apparatus of claim 5 further comprising at least one return valve operative to selectively connect and disconnect the fluid heater and fluid chiller to the return manifold.

7. The apparatus of claim 4 wherein the fluid heater and warm pump are mounted on a transportable heating module, and the fluid chiller and cool pump are mounted on a transportable cooling module.

8. The apparatus of claim 1 wherein the fluid heater comprises a boiler.

9. The apparatus of claim 8 wherein the fluid chiller comprises an absorption chiller.

10. The apparatus of claim 9 wherein the fluid chiller comprises an absorption chiller, and wherein the boiler and absorption chiller use the same type of fuel.

11. The apparatus of claim 1 wherein at least one portable heat exchanger unit comprises a temperature control operative to regulate the flow of fluid through the fluid coil thereof in response to a sensed temperature.

12. The apparatus of claim 1 further comprising a fan controller operative to change the speed of at least one fan.

13. The apparatus of claim 1 wherein at least one portable heat exchanger unit comprises a HEPA filter capable of High Efficient Particulate Attenuation located such that the air stream passes through the HEPA filter.

14. The apparatus of claim 13 further comprising a coarse filter located upstream from the HEPA filter such that the air stream passes through the coarse filter prior to passing through the HEPA filter.

15. The apparatus of claim 13 further comprising an activated carbon filter located upstream from the HEPA filter such that the air stream passes through the activated carbon filter prior to passing through the HEPA filter

16. The apparatus of claim 13 wherein the at least one portable heat exchanger unit further comprises an ultra-violet light oriented to irradiate the air stream with ultra-violet light after the air stream has passed through the HEPA filter.

17. The apparatus of claim 16 further comprising a drip pan oriented to catch condensed water dripping from the fluid coil during a cooling operation, and wherein the ultra-violet light source is oriented to irradiate water collected in the drip pan with ultra-violet light.

18. The apparatus of claim 13 wherein the intake of the at least one portable heat exchanger unit is adapted so that the at least one portable heat exchanger unit draws outside air from outside a first structure, and wherein the outlet of the at least one portable heat exchanger unit is adapted so that the at least one portable heat exchanger unit discharges the air stream into the first structure.

19. A portable apparatus for heating and cooling a plurality of structures, the apparatus comprising:
a portable heating module comprising a fluid heater operative to supply warm fluid and a warm pump operative to pump warm fluid from the fluid heater to an outbound manifold;
a portable cooling module comprising a fluid chiller operative to supply cool fluid and a cool pump operative to pump cool fluid from the fluid chiller to the outbound manifold;
a plurality of portable heat exchanger units, each portable heat exchanger unit comprising a fluid coil and a fan operative to create an air stream through the fluid coil by drawing air from an intake and discharging the air through an outlet;
a return manifold operatively connected to the fluid heater and fluid chiller,
a flexible outbound conduit connecting the outbound manifold to an inlet end of each fluid coil;
a flexible return conduit connecting the return manifold to an outlet end of each fluid coil; and
a control system operative to switch the apparatus between a heating mode, wherein the warm pump pumps warm fluid from the fluid heater through the fluid coils and back to the fluid heater, and a cooling mode wherein the cool pump pumps cool fluid from the fluid chiller through the fluid coils and back to the fluid chiller;
wherein the heating module, cooling module and portable heat exchanger units are operatively connected by releasable connections such that the apparatus can be transported in parts and assembled at a desired destination.

20. The apparatus of claim 19 wherein the outbound and return conduits are releasably connected to the respective inlet and outlet ends of the fluid coils.

21. The apparatus of claim 20 wherein the outbound and return conduits are releasably connected to the respective outbound and return manifolds.

22. The apparatus of claim 19 wherein at least one of the heating and cooling modules comprises a pallet.

23. The apparatus of claim 19 wherein at least one portable heat exchanger unit comprises a HEPA filter capable of High Efficient Particulate Attenuation located such that the air stream passes through the HEPA filter.

24. The apparatus of claim 23 further comprising a coarse filter and an activated carbon filter located upstream from the HEPA filter such that the air stream passes through the coarse and activated carbon filters prior to passing through the HEPA filter.

25. The apparatus of claim 19 wherein the at least one portable heat exchanger unit further comprises an ultra-violet light oriented to irradiate the air stream with ultra-violet light.

26. The apparatus of claim 22 wherein the at least one portable heat exchanger unit further comprises an ultra-violet light oriented to irradiate the air stream with ultra-violet light.

27. The apparatus of claim 26 wherein the ultra-violet light source is oriented to irradiate the air stream with ultra-violet light after the air stream has passed through the HEPA filter.

28. The apparatus of claim 27 further comprising a drip pan oriented to catch condensed water dripping from the fluid coil during a cooling operation, and wherein the ultra-violet light source is oriented to irradiate water collected in the drip pan with ultra-violet light.

29. The apparatus of claim 23 wherein the intake of the at least one portable heat exchanger unit is adapted so that the at least one portable heat exchanger unit draws outside air from outside a first structure, and wherein the outlet of the at least one portable heat exchanger unit is adapted so that the at least one portable heat exchanger unit discharges the air stream into the first structure.

30. A method of heating and cooling a plurality of temporary structures at a camp site, the method comprising:
providing at least two separately transportable modules comprising:
a fluid heater operative to supply warm fluid;
a fluid chiller operative to supply cool fluid;
a plurality of portable heat exchanger units, each portable heat exchanger unit comprising a fluid coil and a fan operative to create an air stream through the fluid coil by drawing air from an intake and discharging the air through an outlet; and
at least one pump;
transporting the at least two transportable modules to the camp site;
operatively connecting the fluid heater, fluid chiller, fluid coils, and at least one pump such that the at least one pump is operative to selectively pump warm fluid and cool fluid through the fluid coils;
orienting the outlet of each portable heat exchanger unit to discharge the air stream into at least one temporary structure;
to heat the temporary structures, pumping warm fluid through the fluid coils and operating the fans to create a warm air stream; and
to cool the temporary structures pumping cool fluid through the fluid coils and operating the fans to create a cool air stream.

31. The method of claim 30 further comprising sensing a temperature in at least one temporary structure and controlling the temperature in the at least one temporary structure by regulating the flow of fluid through the fluid coil in the at least one temporary structure in response to a sensed temperature.

32. The method of claim 30 wherein the fluid heater comprises a boiler.

33. The method of claim 30 wherein the fluid chiller comprises an absorption chiller.

34. The method of claim 32 wherein the fluid chiller comprises an absorption chiller, and wherein the boiler and absorption chiller use the same type of fuel.

35. The method of claim 30 further comprising providing at least one portable heat exchanger unit comprising a HEPA filter capable of High Efficient Particulate Attenuation located such that the air stream passes through the HEPA filter.

36. The method of claim 35 wherein the at least one portable heat exchanger unit further comprises a coarse filter and an activated carbon filter located upstream from the HEPA filter such that the air stream passes through the coarse and activated carbon filters prior to passing through the HEPA filter.

37. The method of claim 30 wherein at least one portable heat exchanger unit further comprises an ultra-violet light oriented to irradiate the air stream with ultra-violet light.

38. The method of claim 35 wherein the at least one portable heat exchanger unit further comprises an ultra-violet light oriented to irradiate the air stream with ultra-violet light after the air stream has passed through the HEPA filter.

39. The method of claim 38 wherein the at least one portable heat exchanger unit further comprises a drip pan oriented to catch condensed water dripping from the fluid coil during a cooling operation, and wherein the ultra-violet light source is oriented to irradiate water collected in the drip pan with ultra-violet light.

40. The method of claim 35 wherein the intake of the at least one portable heat exchanger unit is oriented so that the at least one portable heat exchanger unit draws outside air from outside the temporary structures.

41. The method of claim 30 further comprising adjusting a speed of at least one fan to vary the volume of the air stream created by the at least one fan.
